(19) United States
(12) Patent Application Publication
(10) Pub. No.: US 2025/0307001 A1
(43) Pub. Date: Oct. 2, 2025

(54) Host Accesses to Processing-in-Memory Oriented Data Structures

(71) Applicant: Advanced Micro Devices, Inc., Santa Clara, CA (US)

(72) Inventors: Benjamin Youngjae Cho, Austin, TX (US); Mark Henry Oskin, Clinton, WA (US)

(73) Assignee: Advanced Micro Devices, Inc., Santa Clara, CA (US)

(21) Appl. No.: 18/619,750

(22) Filed: Mar. 28, 2024

(51) Int. Cl. G06F 9/50; G06F 5/08

(52) U.S. Cl. CPC G06F 9/5016; G06F 5/08; G06F 9/505

(57) ABSTRACT

In accordance with the described techniques for host accesses to processing-in-memory oriented data structures, a computing device includes a memory, a host processing unit, and multiple processing-in-memory units each configured to access one or more banks of the memory. The host processor receives an access request to access an element of a data structure stored in the memory. In particular, the access request includes input parameters indicating a processing-in-memory unit of the multiple processing-in-memory units by which the element is accessible, and an offset of the element relative to other elements of the data structure. The host processor generates a memory address based on the processing-in-memory unit and the offset, and the element of the data structure is accessed based on the memory address.

### BACKGROUND

Processing-in-memory (PIM) architectures move processing of memory-intensive computations to memory. This contrasts with standard computer architectures which communicate data back and forth between a memory and a remote processing unit. In terms of data communication pathways, remote processing units of conventional computer architectures are further away from memory than PIM components. As a result, these conventional computer architectures suffer from increased data transfer latency, which can decrease overall computer performance. Further, due to the proximity to memory, PIM architectures also provision higher memory bandwidth and reduced memory access energy relative to conventional computer architectures, particularly when the volume of data transferred between the memory and the remote processing unit is large. Thus, PIM architectures enable increased computer performance while reducing data transfer latency as compared to conventional computer architectures that implement remote processing hardware.

### BRIEF DESCRIPTION OF THE DRAWINGS

FIG. 1 is a block diagram of a non-limiting example system to implement host accesses to processing-in-memory oriented data structures.

FIG. 2 depicts a non-limiting example of generating a memory address for an access request using reconfigurable routing logic.

FIG. 3 depicts a non-limiting example of a layout of a matrix in memory for efficient execution of general matrix-vector multiplication operations using processing-in memory.

FIG. 4a depicts a non-limiting example of generating a memory address for an access request to access an element of a matrix having the layout of FIG. 3.

FIG. 4b depicts non-limiting examples of different partitionable portions of the matrix of FIG. 3

FIG. 5 depicts a procedure in an example implementation of host accesses to processing-in-memory oriented data structures.

### DETAILED DESCRIPTION

### Overview

A memory architecture includes a host processor that is communicatively coupled via a connection (e.g., a wired and/or wireless connection) to a memory module that includes a memory and multiple processing-in-memory (PIM) units. Each PIM unit is communicatively coupled to one or more banks of the memory. That is, a respective PIM unit is capable of directly accessing (e.g., reading data from and writing data to) the one or more banks to which the PIM unit is communicatively coupled, e.g., the banks that are local to the respective PIM unit. However, in order for a PIM unit to access data stored in other non-local banks of the memory, the host processor facilitates the access, e.g., due to a lack of inter-bank communication substrate in various memory architectures. For a PIM unit to access non-local data, for instance, the data is first communicated to the host processor and then communicated to a destination storage location in memory or registers of the PIM unit.

These host-facilitated accesses of data are relatively long latency operations (in comparison to direct accesses of data by the PIM unit), and also cause significant traffic on (and contention for) the memory channels between the host processor and the memory. Due to this, data structures are often laid out in memory in a manner that is efficient for operating on the data structures using the PIM units. One example of laying out a data structure in a PIM oriented manner includes localizing interacting elements of a data structure (e.g., elements that are often operated on together) to bank(s) that are operated on by just one PIM unit, thereby limiting cross PIM unit data movement. In various implementations, the PIM units are single instruction, multiple data (SIMD) in-memory processors including multiple lanes, and each lane of the multiple PIM units is capable of performing a single operation on different data in parallel. Given this, another example of laying out a data structure in a PIM oriented manner includes mapping different sets of interacting elements to different lanes across the multiple PIM units, thereby maximizing in-parallel processing of operations on the different sets of the interacting elements.

While these PIM oriented layouts improve efficiency for processing data structures using the PIM units, the PIM oriented layouts create inefficiencies for accessing the data structure by the host processor. Due to the complexity of the PIM-oriented layouts, for example, the host processor spends an increased number of processor cycles calculating a memory address from which to access a particular element of the data structure laid out in the PIM oriented manner, e.g., as compared to a data structure laid out in a typical or host oriented manner.

To solve these problems, routing logic is implemented by the host processor to generate a memory address for an access request to access an element of a data structure laid out in the PIM oriented manner. As part of this, the host processor includes a physical address map, and the physical address map includes one or more mappings that assign bit positions of a physical memory address to corresponding components of the memory. An example mapping specifies which bit positions in a memory address identify a memory channel of the memory address, a PIM unit that accesses the memory address, a bank of the memory address, a row of the memory address, and a column of the memory address. In one or more implementations, the physical address map includes different mappings each assigning different bit positions of physical memory addresses to the corresponding components of the memory.

In accordance with the described techniques, the host processor receives a workload that accesses the data structure along with a mapping of the physical address map specified for the workload. Further, the routing logic receives an access request of the workload to access a particular element of the data structure laid out in the PIM oriented manner, and the access request includes input parameters indicating a PIM unit identifier and an offset identifier. Broadly, the PIM unit identifier specifies a particular PIM unit of the multiple PIM units in the system that is configured to access one or more banks where the requested element of the data structure is stored. Further, the offset identifier specifies an offset of the requested element relative to other elements of the data structure stored in the one or more banks operated on by the particular PIM unit. In one or more implementations, the PIM unit identifier and the offset identifier are provided directly via the input parameters. Additionally or alternatively, the input parameters include element parameters indicating the particular element of the data structure and layout parameters indicating how the elements of the data structure are laid out, and the PIM unit identifier and the offset identifier are computed based on the element parameters and the layout parameters.

Regardless of whether the PIM unit identifier and the offset identifier are provided directly via the input parameters or computed based on the input parameters, the routing logic generates a memory address for the access request based on the mapping specified for the workload, the PIM unit identifier, and the offset identifier. By way of example, the PIM unit identifier and the offset identifier are binary identifiers having source bit positions corresponding to the various memory components. To generate the memory address, the routing logic implements a routing protocol corresponding to the mapping specified for the workload. The routing protocol, for example, specifies how source bit positions of the PIM unit identifier and the offset identifier are to be routed to destination bit positions of the memory address that are assigned (based on the mapping) to corresponding components of the memory. Given this, the routing logic generates the memory address for the access request by routing source bits of the PIM unit identifier and the offset identifier to destination bit positions of the memory address in accordance with the routing protocol.

By leveraging the described input parameters for memory address generation, the described techniques utilize fewer instructions and fewer operations to calculate memory addresses for data structures laid out in the PIM oriented manner, as compared to conventional techniques. In other words, the described techniques accelerate host accesses to data structures laid out in the PIM oriented manner.

In some aspects, the described techniques relate to a computing device, comprising a memory, multiple processing-in-memory units, each processing-in-memory unit configured to access one or more banks of the memory, and a host processor configured to receive an access request to access an element of a data structure stored in the memory, the access request including input parameters indicating a processing-in-memory unit of the multiple processing-in-memory units by which the element is accessible, and an offset of the element relative to other elements of the data structure, and generate a memory address for the access request based on the processing-in-memory unit and the offset, the element of the data structure being accessed based on the memory address.

In some aspects, the described techniques relate to a computing device, wherein the processing-in-memory unit and the offset are specified directly via the input parameters.

In some aspects, the described techniques relate to a computing device, wherein the offset further indicates a particular bank of the one or more banks that the processing-in-memory unit is configured to access.

In some aspects, the described techniques relate to a computing device, wherein the host processor is configured to generate the memory address using a physical address map, the physical address map including one or more mappings that assign bit positions of the memory address to corresponding components of the memory.

In some aspects, the described techniques relate to a computing device, wherein the corresponding components of the memory include memory channels, the multiple processing-in-memory units, banks of the memory, rows of the banks, and columns of the banks.

In some aspects, the described techniques relate to a computing device, wherein the processing-in-memory unit and the offset are indicated by one or more numerical identifiers, and to generate the memory address, the host processor is configured to route source bits of the one or more numerical identifiers to the bit positions of the memory address in accordance with a routing protocol corresponding to a mapping of the physical address map.

In some aspects, the described techniques relate to a computing device, wherein the routing protocol is hardwired into the host processor.

In some aspects, the described techniques relate to a computing device, wherein the routing protocol is implemented by barrel shifters of the host processor that are reconfigurable to account for different mappings of the physical address map.

In some aspects, the described techniques relate to a computing device, wherein the access request is received as part of a workload, and to generate the memory address, the host processor is configured to receive an indication of the mapping of the physical address map associated with the workload, update machine status registers of the host processor to specify the routing protocol corresponding to the mapping, and reconfigure the barrel shifters to implement the routing protocol as specified by the machine status registers.

In some aspects, the described techniques relate to a computing device, wherein the host processor is configured to store elements of the data structure in the memory in a layout, the layout including interacting elements of the data structure stored at locations in the memory that are local to respective processing-in-memory units of the multiple processing-in-memory units.

In some aspects, the described techniques relate to a computing device, wherein the multiple processing-in-memory units correspond to single instruction, multiple data processing-in-memory units each having multiple lanes, the layout further including the interacting elements of the data structure stored at the locations in the memory that map to respective lanes of the multiple processing-in-memory units.

In some aspects, the described techniques relate to a computing device, wherein the input parameters include element parameters indicating the element of the data structure and layout parameters indicating the layout, and the host processor is further configured to compute the processing-in-memory unit and the offset based on the element parameters and the layout parameters.

In some aspects, the described techniques relate to a system, comprising a memory module including a memory and multiple processing-in-memory units each configured to access one or more banks of the memory, and a host processor communicatively coupled to the memory module, the host processor configured to store elements of a matrix in the memory in a layout, the layout including interacting elements of the matrix stored at locations in the memory that map to respective lanes of the multiple processing-in-memory units, receive an access request to access an element of the matrix, the access request including element parameters indicating the element, and layout parameters indicating the layout, and compute, based on the element parameters and the layout parameters, a processing-in-memory unit of the multiple processing-in-memory units by which the element is accessible and an offset of the element relative to other elements of the matrix, the element of the matrix being accessed based on the processing-in-memory unit and the offset.

In some aspects, the described techniques relate to a system, wherein the interacting elements include the elements of the matrix that are combinable as part of a reduction computation of a general matrix-vector multiplication operation.

In some aspects, the described techniques relate to a system, wherein the element parameters include a row of the matrix and a column of the matrix associated with the element.

In some aspects, the described techniques relate to a system, wherein the layout parameters include a first number of bank columns allocated to the matrix in the one or more banks of the multiple processing-in-memory units, a second number of lanes included in each of the multiple processing-in-memory units, a third number of the multiple processing-in-memory units, a fourth number of matrix columns in the matrix, and a base type size of the elements in the matrix.

In some aspects, the described techniques relate to a system, wherein the host processor is further configured to generate a memory address for the access request based on the processing-in-memory unit and the offset, the memory address generated using a physical address map that includes one or more mappings that assign bit positions of the memory address to different components of the memory, the element of the matrix being accessed based on the memory address.

In some aspects, the described techniques relate to a system, wherein the processing-in-memory unit and the offset are indicated by one or more numerical identifiers, and to generate the memory address, the host processor is configured to route source bits of the one or more numerical identifiers to the bit positions of the memory address in accordance with a routing protocol corresponding to a mapping of the physical address map specified for a workload that includes the access request.

In some aspects, the described techniques relate to a method, comprising receiving, by a host processor, an access request of a workload to access an element of a data structure stored in memory, the access request including numerical identifiers of a processing-in-memory unit that is configured to access a bank where the element is stored and an offset of the element relative to other elements of the data structure, generating, by the host processor, a memory address for the access request using a routing protocol indicating how source bits of the numerical identifiers are routed to bit positions of the memory address assigned to respective components of the memory, and accessing, by the host processor, the element of the data structure based on the memory address.

In some aspects, the described techniques relate to a method, wherein the routing protocol is implemented in hardware of the host processor that is reconfigurable to account for different mappings of bit positions of the memory address to corresponding components of the memory, and generating the memory address includes receiving a mapping associated with the workload, updating machine status registers of the host processor to specify the routing protocol corresponding to the mapping, and reconfiguring the hardware to implement the routing protocol as specified by the machine status registers.

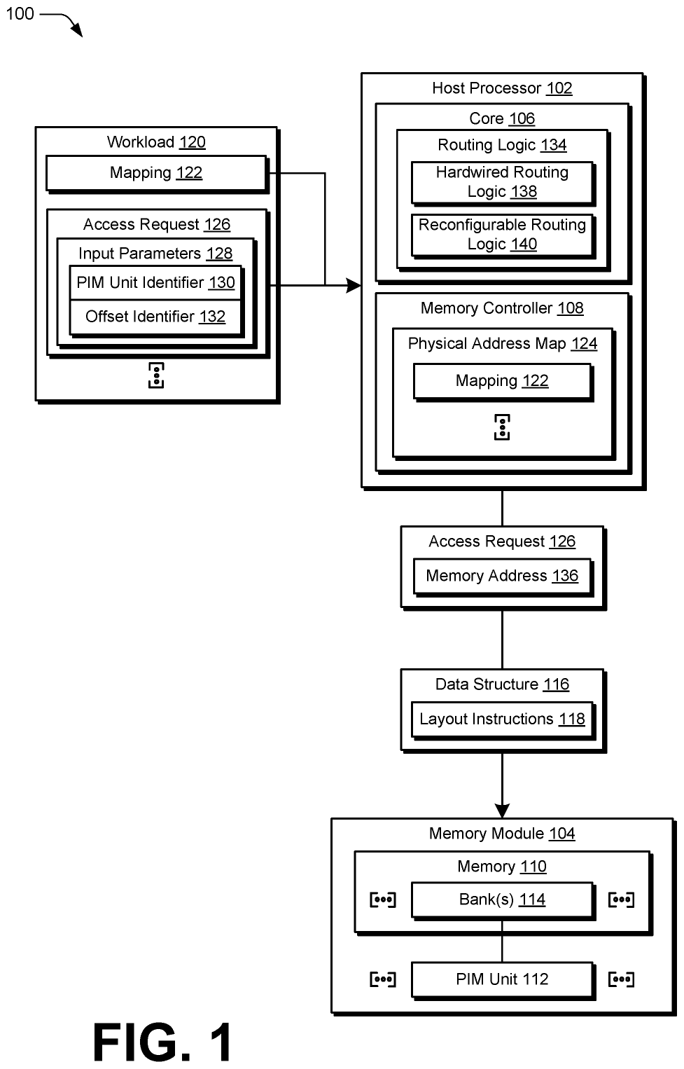

FIG. 1 is a block diagram of a non-limiting example system 100 to implement host accesses to processing-in-memory oriented data structures. The system 100 includes a host processor 102 and a memory module 104. Further, the host processor 102 includes a core 106 and a memory controller 108, and the memory module 104 includes a memory 110 and multiple processing-in-memory (PIM) units 112.

In accordance with the described techniques, the host processor 102 and the memory module 104 are coupled to one another via one or more wired or wireless connections. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host processor 102 is an electronic circuit that performs various operations on and/or using data in the memory 110. Examples of the host processor 102 and/or the core 106 include, but are not limited to, a central processing unit (CPU), a graphics processing unit (GPU), and a field programmable gate array (FPGA). For example, the core 106 is a processing unit that reads and executes requests/instructions (e.g., of a program), examples of which include to add data, to move data, and to branch. Although one core 106 is depicted in the example system 100, the host processor 102 includes more than one core 106 in variations, e.g., the host processor 102 is a multi-core processor.

In one or more implementations, the memory module 104 is a circuit board (e.g., a printed circuit board), on which the memory 110 is mounted and includes the PIM units 112. Examples of the memory module 104 include, but are not limited to, a TransFlash memory module, a single in-line memory module (SIMM), and a dual in-line memory module (DIMM). In one or more implementations, the memory module 104 is a single integrated circuit device that incorporates the memory 110 and the PIM units 112 on a single chip. In some examples, the memory module 104 is composed of multiple chips that implement the memory 110 and the PIM units 112 that are vertically (“3D”) stacked together, are placed side-by-side on an interposer or substrate, or are assembled via a combination of vertical stacking or side-by-side placement.

The memory 110 is a device or system that is used to store information, such as for immediate use in a device, e.g., by the core 106 of the host processor 102 and/or by the PIM units 112. In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 110 is configurable in a variety of ways that support host accesses to processing-in-memory oriented data structures without departing from the spirit or scope of the described techniques.

The memory controller 108 is a digital circuit that manages the flow of data to and from the memory 110. By way of example, the memory controller 108 includes logic to read and write to the memory 110. In one or more implementations, the memory controller 108 also includes logic to interface with the PIM units 112, e.g., to provide commands to the PIM units 112 for processing. The memory controller 108 also interfaces with the core 106. For instance, the memory controller 108 receives commands from the core 106 which involve accessing the memory 110 and/or the PIM unit 112 and provides data to the core 106 for processing. In one or more implementations, the memory controller 108 is communicatively and/or topologically located between the core 106 and the memory module 104, and the memory controller 108 interfaces with the core 106 and the memory module 104.

Broadly, the PIM units 112 correspond to in-memory processors. The PIM units 112, for instance, are electronic circuits embedded within the memory module 104 to process data in memory 110 entirely within the memory module 104. The in-memory processors are implemented with example processing capabilities ranging from relatively simple (e.g., an adding machine) to relatively complex, e.g., a CPU/GPU compute core. Broadly, the host processor 102 is configured to offload memory bound computations to the PIM units 112. To do so, the host processor 102 generates PIM commands (e.g., by the core 106) and transmits the PIM commands (e.g., by the memory controller 108) to the memory module 104. The PIM units 112 receive the PIM commands and process the PIM commands utilizing data stored in the memory 110. While the PIM units 112 are illustrated as being disposed within the memory module 104, it is to be appreciated that in some examples, the described benefits of host accesses to processing-in-memory oriented data structures are realizable through near-memory processing implementations in which one or more of the PIM units 112 are disposed in closer proximity to the memory 110 (e.g., in terms of data communication pathways and/or topology) than the core 106 of the host processor 102.

Processing-in-memory using in-memory processors contrasts with processing data using the host processor 102. Indeed, host-based data processing involves communication of the data from the memory 110 to the core 106 of the host processor 102, and processing the data using the core 106 rather than the PIM units 112. In various scenarios, the data produced by the core 106 as a result of processing the obtained data is written back to the memory 110, which involves communication of the data back to the memory 110. In terms of data communication pathways, the core 106 is further away from the memory 110 than the PIM units 112. Given this, processing data using the PIM units 112 enables increased computer performance while reducing data transfer energy and increasing memory bandwidth, as compared to processing data using the host processor 102. Additionally, processing data using the PIM units 112 alleviates memory performance and energy bottlenecks by moving one or more memory-intensive computations closer to memory 110.

As shown, each PIM unit 112 in the system 100 is communicatively coupled to one or more banks 114 of the memory 110 via wired and/or wireless connections, e.g., buses (e.g., data buses), interconnects, traces, and planes. That is, a respective PIM unit 112 is configured to process PIM commands by operating on data stored in the one or more banks 114 to which the respective PIM unit 112 is communicatively coupled. In variations, a respective PIM unit 112 operates on just one bank 114 of the memory 110, two or more banks 114 of the memory 110, the banks 114 of a memory rank of the memory 110, or the banks 114 of a memory channel of the memory 110.

In one or more implementations, the memory module 104 and/or the memory 110 include various memory components (e.g., memory channels, the PIM units 112, the banks 114, and rows and columns of the banks 114) that are organized hierarchically. By way of example, the memory architecture includes a certain number of memory channels which facilitate communication of data between the banks 114 and the host processor 102. Further, each memory channel facilitates communication of data to and from the banks 114 that are assigned to a certain number of PIM units 112. In addition, each PIM unit 112 operates on one or more banks 114 of the memory 110, and each bank 114 is divided into rows and columns such that an individual data element is stored in a memory cell associated with a row and column pair.

It should be noted that a PIM unit 112 is capable of directly accessing (e.g., reading data from and writing data to) the one or more banks 114 that are local to the PIM unit 112, e.g., the banks 114 to which the PIM unit 112 is communicatively coupled. However, in order to access data stored in other banks 114 of the memory 110 (which are non-local to the PIM unit 112), the host processor 102 facilitates the access, e.g., due to a lack of inter-bank communication substrates in various memory architectures. In order to load non-local data into registers of the PIM unit 112, for example, the host processor 102 reads the data from the non-local banks 114 of the memory 110 and writes the data to the registers of the PIM unit 112. Notably, host-facilitated accesses of data are slower than direct accesses by the PIM unit 112, and cause significant traffic on (and contention for) the memory channels between the host processor 102 and the memory 110.

Thus, in order to facilitate efficient execution of operations on data structures using the PIM units 112, it is important for the data structures to be laid out in memory 110 in a manner that minimizes cross PIM unit 112 data movement. To do so, the host processor 102 communicates a data structure 116 for storage in the memory 110, along with layout instructions 118 specifying how the data structure 116 is to be laid out in memory 110. More specifically, the host processor 102 performs store operations on elements of the data structure based on the layout instructions 118 which are received through execution of a software program. Generally, the layout instructions 118 store the elements of the data structure 116 in a layout, and the layout is a distribution of the elements across one or more banks 114 operated on by one or more PIM units 112 to facilitate parallel processing of respective sets of interacting elements (e.g., elements of the data structure 116 that are operated on together as part of a single computation) by the one or more PIM units 112.

In general, a data structure 116 is a specialized format for organizing, processing, and storing data elements. Examples of the data structure 116 include, but are not limited to, matrices, vectors, trees, heaps, arrays, and queues. Data elements of a data structure 116 include integers, characters, strings, objects, and/or other data structures. In an example, the data structure 116 is a matrix having n rows and m columns, and having data elements (e.g., integers) corresponding to each unique row and column combination.

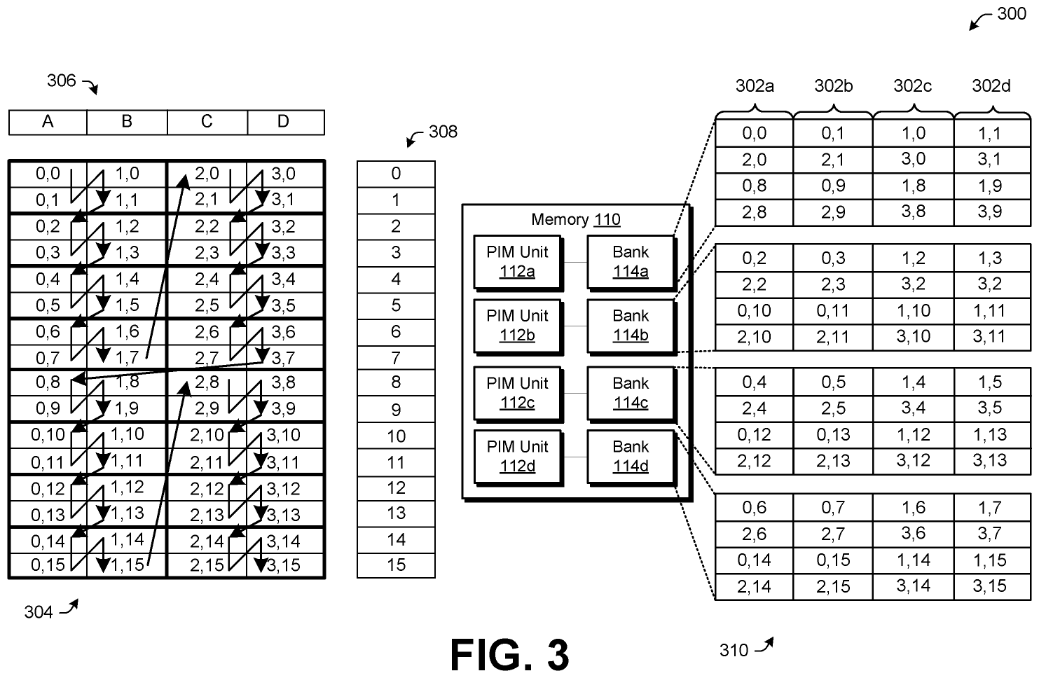

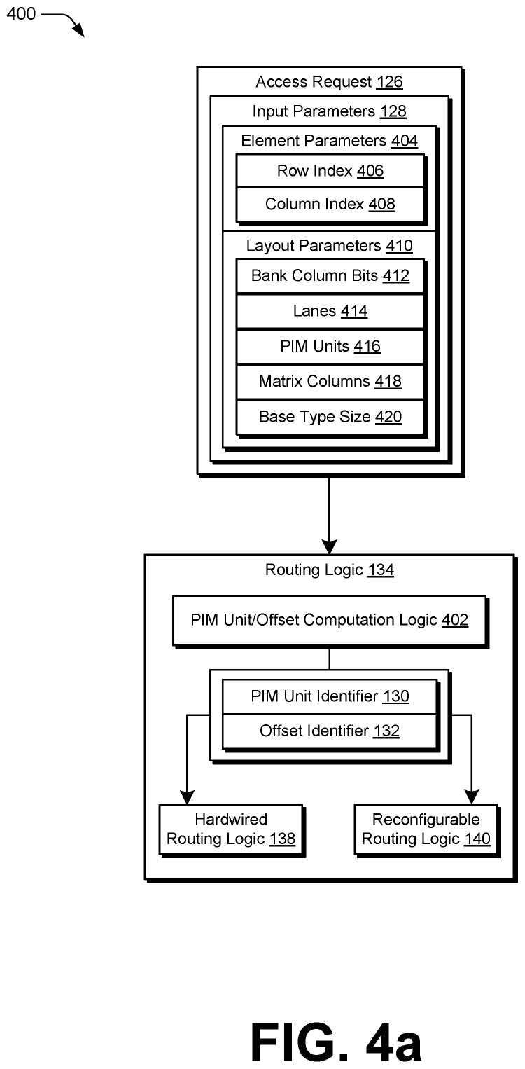

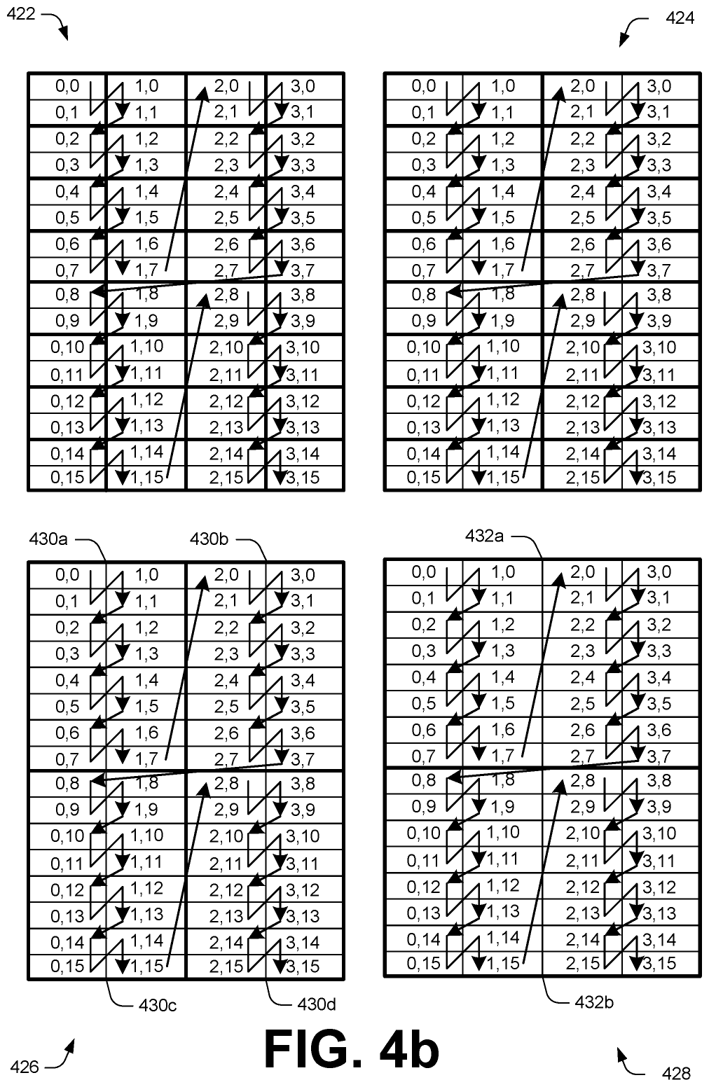

Broadly, the layout instructions 118 cause interacting elements of the data structure 116 to be stored in the one or more banks 114 that are local to a respective PIM unit 112. Notably, “interacting elements” are elements of the data structure 116 that are frequently operated on together, e.g., the interacting elements are frequently added together, subtracted from one another, multiplied together, etc. In at least one example, and as further discussed below with reference to FIGS. 3 and 4, a set of interacting elements of a matrix include the elements of a particular row of the matrix. These elements are “interacting” in the sense that the elements in the particular row are accumulated together as part of a reduction computation in general matrix-vector multiplication (GEMV) operations. By localizing sets of interacting elements of the data structure 116 to respective PIM units 112 of the system 100, the layout instructions 118 reduce non-local accesses of data by the PIM units 112.

In one or more implementations, the PIM units 112 are single instruction, multiple data (SIMD) in-memory processors having multiple lanes that are each capable of performing a single operation on different data in parallel. Thus, the layout instructions 118 further store different sets of interacting elements of the data structure 116 at locations in the memory 110 that are mapped to different lanes across the multiple PIM units 112. By way of example, a first set of interacting elements are mapped to a first lane of a first PIM unit 112, a second set of interacting elements are mapped to a second lane of the first PIM unit 112, a third set of interacting elements are mapped to a first lane of a second PIM unit 112, a fourth set of interacting elements are mapped to a second lane of the second PIM unit 112, and so on. By laying out the data structure 116 in this manner, different sets of interacting elements are directly loadable into corresponding lanes of the multiple PIM units 112 (e.g., without shifting the data), and a single operation is performable on the different sets of interacting elements in parallel by respective lanes of the respective PIM units 112 in the system 100.

While the above-described layout is efficient for performing operations on the data structure 116 using the PIM units 112, the layout creates inefficiencies for accessing the data structure 116 by the host processor 102. Due to the complexity of the above-described layout, for instance, the host processor 102 spends an increased number of processor cycles calculating a memory address from which to access a particular element of the data structure 116 laid out in the PIM oriented manner, e.g., as compared to a data structure 116 laid out in a typical or host oriented manner.

In order to alleviate these inefficiencies, techniques for host accesses to processing-in-memory oriented data are described. In accordance with the described techniques, the host processor 102 receives a workload 120 that accesses the data structure 116 along with an indication of a mapping 122 for the workload 120. For instance, the memory controller 108 includes a physical address map 124 (e.g., a physical-to-memory component address map, a physical-to-DRAM component address map), which is a data structure (e.g., stored locally in the host processor 102 and/or the memory 110) that includes one or more mappings 122 that assign bit positions of a memory address to corresponding components of the memory 110.

The mapping 122, for example, specifies channel bit positions of a memory address, which when populated, identify a memory channel where a data element is stored. Additionally or alternatively, the mapping 122 specifies PIM unit bit positions of a memory address, which when populated, identify a PIM unit 112 by which the data element is accessible. Additionally or alternatively, the mapping 122 specifies bank bit positions, which when populated, identify a particular bank 114 of the one or more banks operated on by the PIM unit 112 where the data element is stored. Additionally or alternatively, the mapping 122 specifies row bit positions and column bit positions, which when populated identify a particular row and column pair in the bank 114 where the data element is stored.

It should be noted that different data structures 116 include elements that interact differently, and as such, different data structures 116 are laid out differently to support efficient execution of operations on the different data structures 116. Further, different mappings 122 maximize access efficiency for different layouts of different data structures, e.g., due to different access patterns for the different layouts. For this reason, the physical address map 124 includes different mappings 122 optimal for different data structures, in one or more implementations, and the different mappings 122 assign different bit positions of memory addresses to the corresponding components of the memory 110. Since the workload 120 accesses the data structure 116, the mapping 122 specified for the workload 120 is the mapping 122 that maximizes access efficiency for the particular layout of the data structure 116.

In accordance with the described techniques, the workload 120 includes an access request 126 to access an element of the data structure 116 laid out in the PIM oriented manner. Further, the access request 126 includes input parameters 128 including a PIM unit identifier 130 and an offset identifier 132. In one or more examples, the input parameters 128 (e.g., the PIM unit identifier 130 and the offset identifier 132) are dedicated bits of the access request 126, i.e., the PIM unit identifier 130 corresponds to a first range of bit positions in the access request 126, and the offset identifier 132 corresponds to a second range of bit positions in the access request 126.

The PIM unit identifier 130 specifies a PIM unit 112 by which the requested element is accessible. For example, the PIM unit 112 specified by the PIM unit identifier 130 is the PIM unit 112 that operates on a set of one or more banks 114 where the requested element is stored. Further, the offset identifier 132 specifies an offset of the requested element relative to other elements (e.g., elements other than the requested element) of the data structure 116 stored in the one or more banks 114 operated on by the PIM unit 112.

More specifically, the offset is a number of data elements (e.g., the “other elements”) of the data structure 116 stored within the one or more banks 114 (operated on by the PIM unit 112 specified by the PIM unit identifier 132) that are laid out before the requested element in the data structure 116. Consider an example in which the PIM unit identifier 130 identifies a PIM unit 112 that operates on four banks 114, and the data structure 116 is laid out in sixteen rows (e.g., four rows per bank and four columns across the four banks 114, i.e., each bank 114 of the four banks 114 stores sixteen elements of the data structure 116. In this example, the requested element is in the first row and the third column of the third bank, and as such, the offset is thirty-four elements, e.g., sixteen elements in the first bank, sixteen elements in the second bank, and two elements in the third bank are laid out before the requested element.

In one or more implementations, the input parameters 128 correspond to the PIM unit identifier 130 and the offset identifier 132, e.g., the PIM unit identifier 130 and the offset identifier 132 are specified directly via the input parameters 128. Additionally or alternatively, the input parameters 128 indicate a particular element of the data structure 116 as well as how the elements of the data structure 116 are laid out, and PIM unit/offset calculation logic is implemented to compute the PIM unit identifier 130 and the offset identifier 132 based on the input parameters 128, as further discussed below with reference to FIGS. 4a and 4b.

In various implementations, the PIM unit identifier 130 and the offset identifier 132 are numerical identifiers (e.g., blocks of binary numbers) that identify specific memory components. Consider an example in which there are eight memory channels, thirty-two PIM units 112 per memory channel, and each PIM unit 112 operates on two banks 114 of the memory 110. In this example, the requested element of the data structure 116 is stored in a second column and a first row of a first bank 114 of the sixth PIM unit 112 which belongs to a fourth memory channel. Given this, the PIM unit identifier 130 includes a set of bits that are a binary identifier of the fourth memory channel, and a set of bits that are a binary identifier of the sixth PIM unit 112. Further, the offset identifier 132 includes a set of bits that are a binary identifier of the first bank 114, a set of bits that are a binary identifier of the second column of the first bank 114, and a set of bits that are a binary identifier of the eleventh row of the first bank 114.

As shown, the indication of the mapping 122 specified for the workload 120 and the access request 126 are received by routing logic 134 running on the core 106 of the host processor 102. Broadly, the routing logic 134 is configured to generate a memory address 136 for the access request 126 based on the PIM unit identifier 130 and the offset identifier 132. To do so, the routing logic 134 implements a routing protocol corresponding to the mapping 122. For instance, the routing protocol specifies how source bit positions of the PIM unit identifier 130 and the offset identifier 132 are to be routed to destination bit positions of the memory address 136 that are assigned (based on the mapping 122 of the physical address map 124) to corresponding components of the memory 110.

Consider an example in which the mapping 122 specifies that bit position through bit position in a sixty four bit memory address space are channel bits assigned to specifying a memory channel of a memory address. Further, bit position [0] through bit position [3] of the PIM unit identifier 130 identify the memory channel to which the requested element belongs. In this example, the routing protocol indicates that bit position [0] of the PIM unit identifier 130 is routed (e.g., copied) to bit position of the memory address 136, bit position [1] of the PIM unit identifier 130 is routed (e.g., copied) to bit position of the memory address 136, and so forth. The routing protocol similarly routes source bit positions of the PIM unit identifier 130 and the offset identifier 132 to destination bits of the memory address 136 assigned to corresponding memory components, as indicated by the mapping 122.

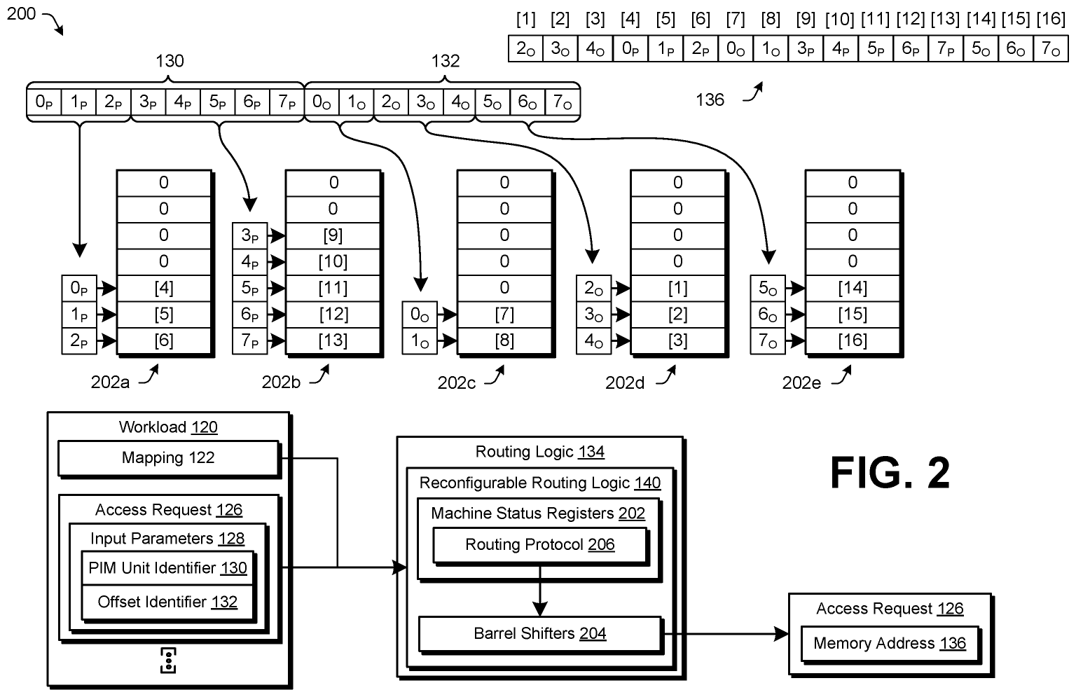

As shown, the routing logic 134 includes hardwired routing logic 138 and reconfigurable routing logic 140. The hardwired routing logic 138 includes one or more routing protocols (corresponding to one or more mappings 122 of the physical address map 124) that are hardwired into the host processor 102. In contrast, the reconfigurable routing logic 140 is implemented in hardware that is reconfigurable to implement routing protocols corresponding to different mappings 122 of the physical address map 124, as further discussed below with reference to FIG. 2.

Thus, the routing logic 134 leverages the hardwired routing logic 138 or the reconfigurable routing logic 140 based on the mapping 122 specified for the workload 120. For example, if the mapping 122 corresponds to a routing protocol of the one or more routing protocols implemented by the hardwired routing logic 138, the routing logic 134 leverages the hardwired routing logic 138 to generate the memory address 136. If the routing protocol of the mapping 122 is not implemented by the hardwired routing logic 138, the routing logic 134 determines whether the hardware of the reconfigurable routing logic 140 is currently configured for the routing protocol corresponding to the mapping 122. If the hardware is configured for the routing protocol of the mapping 122, the routing logic 134 leverages the reconfigurable routing logic 140 to generate the memory address 136 (without reconfiguring the hardware). If, however, the hardware is not configured for the routing protocol of the mapping 122, the routing logic 134 first reconfigures the hardware of the reconfigurable routing logic 140 to implement the routing protocol of the mapping 122, and then leverages the reconfigurable routing logic 140 to generate the memory address 136.

Since different mappings 122 maximize access efficiency for different layouts of different data structures, the reconfigurable routing logic 140 improves access efficiency by using a wide variety of mappings 122 for workloads that access different layouts of different data structures in memory 110. However, additional processor cycles are spent by the host processor 102 reconfiguring the hardware of the reconfigurable routing logic 140. Thus, by hardwiring routing protocols of frequently used mappings 122 of the physical address map 124 as part of the hardwired routing logic 138, the host processor 102 avoids the additional reconfiguration processor cycles for workloads accessing data structures that utilize common layouts. Regardless of whether the routing protocol corresponding to the mapping 122 is implemented in the hardwired routing logic 138 or the reconfigurable routing logic 140, the memory address 136 is generated by routing source bits of the PIM unit identifier 130 and the offset identifier 132 to destination bit positions of the memory address 136 in accordance with the routing protocol.

The generation of the memory address 136 by the routing logic 134 of the described techniques is performed in significantly fewer processor cycles than conventional techniques for accessing PIM oriented data structures. Indeed, by leveraging the described input parameters 128, the described techniques utilize fewer instructions and fewer operations to calculate the memory address 136 as compared to conventional techniques. For example, in scenarios in which the PIM unit identifier 130 and the offset identifier 132 are provided directly by the input parameters 128, the routing logic 134 utilizes just one processor cycle to generate the memory address 136 (excluding any processor cycles spent reconfiguring the hardware of the reconfigurable routing logic 140). Therefore, the described techniques significantly accelerate host accesses to PIM oriented data structures, as compared to conventional techniques.

FIG. 2 depicts a non-limiting example 200 of generating a memory address for an access request using reconfigurable routing logic. The example 200 includes the workload 120, the mapping 122 specified for the workload 120, and an access request 126. The access request 126 includes input parameters 128 indicating the PIM unit identifier 130 and the offset identifier 132. As shown, an indication of the mapping 122 and the access request 126 are received by the routing logic 134 including the reconfigurable routing logic 140. The indication of the mapping 122, for instance, is an instruction requesting the routing logic 134 to select the mapping 122 (e.g., from among the multiple mappings 122 of the physical address map 124) for generating memory addresses 136 for access requests 126 of the workload 120. Broadly, the reconfigurable routing logic 140 is implemented using machine status registers 202 and barrel shifters 204 that are reconfigurable to implement routing protocols associated with different mappings 122.

In particular, the reconfigurable routing logic 140 initially receives an indication of the mapping 122 for the workload 120. The indication of the mapping 122, for example, is received before the access requests 126 of the workload 120, and dictates that the indicated mapping 122 of the physical address map 124 is to be used for generating memory addresses 136 for the access requests 126 of the upcoming workload 120. Upon receiving the indication of the mapping 122, the routing logic 134 determines whether the routing logic 134 is currently configured for generating memory addresses using the mapping 122. In the example 200, the routing logic 134 is not configured for generating memory addresses using the mapping 122. This is because the hardwired routing logic 138 does not include the routing protocol corresponding to the mapping 122, and the barrel shifters 204 of the reconfigurable routing logic 140 are currently configured for implementing a routing protocol of a different mapping 122.

Accordingly, the reconfigurable routing logic 140 reconfigures the barrel shifters 204 to implement the routing protocol 206 corresponding to the mapping 122. As part of this, the reconfigurable routing logic 140 updates the machine status registers 202 to specify the routing protocol 206 corresponding to the mapping 122. The machine status registers 202, for instance, are registers (small data storage mechanisms) implemented in circuitry of the host processor 102 that store status flags and/or control bits which control the behavior and operation of the host processor 102, which in the present case, includes controlling how the host processor 102 routes source bit positions of the input parameters 128 to destination bit positions of a memory address 136. For instance, each of the machine status registers 202 includes a number of entries, and a value of a respective entry specifies how a source bit position of the PIM unit identifier 130 and/or the offset identifier 132 is to be routed to a destination bit position of the memory address 136 in accordance with the mapping 122. Broadly, the reconfigurable routing logic 140 updates the machine status registers 202 by writing values to the entries in the machine status registers 202 such that the values indicate the routing protocol 206 corresponding to the mapping 122.

Consider the illustrated example 200 in which there are five machine status registers 202a, 202b, 202c, 202d, 202e. In the example 200, machine status register 202a is used for specifying bit positions of the memory address 136 which identify a memory channel of the memory address 136, the machine status register 202b is used for specifying bit positions of the memory address 136 which identify a PIM unit 112 of the memory address 136, the machine status register 202c is used for specifying bit positions of the memory address 136 which identify a bank 114 of the memory address 136, the machine status register 202d is used for specifying bit positions of the memory address 136 which identify a column of the memory address 136, and the machine status register 202e is used for specifying bit positions of the memory address 136 which identify a row of the memory address 136.

As previously mentioned, the PIM unit identifier 130 includes a set of bits that are a binary identifier of a memory channel and a set of bits that are a binary identifier of a PIM unit 112 in various implementations. Thus, the reconfigurable routing logic 140 is aware of which source bit positions of the PIM unit identifier 130 correspond to a memory channel identifier, and which source bit positions of the PIM unit identifier 130 correspond to an identifier of a PIM unit 112 within the identified memory channel. Similarly, the offset identifier 132 includes a set of bits that are a binary identifier of a bank, a set of bits that are a binary identifier of a bank column, and a set of bits that are a binary identifier of a bank row. Given this, the reconfigurable routing logic 140 is aware of which source bit positions of the offset identifier 132 correspond to a memory bank identifier, which source bit positions of the offset identifier 132 correspond to a bank column identifier, and which source bit positions of the offset identifier 132 correspond to a bank row identifier.

Based on the known correspondence of source bit positions of the identifiers 130, 132 to different memory components and the correspondence (indicated by the mapping 122) of the destination bit positions of the memory address 136 to the different memory components, the reconfigurable routing logic 140 writes values to the machine status registers 202. In the illustrated example 200, for instance, the first three bits of the PIM unit identifier 130 are known to correspond to a memory channel identifier, and the mapping 122 indicates that bit positions [4], [5], and [6] correspond to memory channel identification bits of the memory address 136. Thus, the reconfigurable routing logic 140 writes the values [4], [5], and [6] to the machine status register 202a, which specifies routing of bit position [0], [1], and [2] of the PIM unit identifier 130 to bit position [4], [5], and [6], respectively, of the memory address 136. This process is repeated for each of the machine status registers 202.

In the example 200, the machine status registers 202a, 202b make up the routing protocol 206 for the PIM unit identifier 130, while the machine status registers 202c, 202d, 202e make up the routing protocol 206 for the offset identifier 132. In addition, the bit positions of the PIM unit identifier 130 are denoted with a subscript “P,” while the bit positions of the offset identifier 132 are denoted with a subscript “O” in the illustrated example 200. Furthermore, a value of [0] in the machine status registers 202 indicates an empty value, e.g., a value that is not used as part of the routing protocol 206. Thus, the routing protocol 206 specified via a respective machine status register 202 begins with a first non-zero value in the respective machine status register 202.

Given the above, the routing protocol 206 specified via the machine status registers 202 in the illustrated example 200 routes a first grouping of source bit positions [0_{P}], [1_{P}], and [2_{P}] of the PIM unit identifier 130 (e.g., the memory channel ID) to destination bit positions [4], [5], and [6], respectively, of the memory address 136. Further, the routing protocol 206 routes a next, successive grouping of source bit positions [3_{P}], [4_{P}], [5_{P}], [6_{P}], and [7_{P}] (e.g., the PIM unit 112 ID) of the PIM unit identifier 130 to destination bit positions [9], [10], [11], [12], and [13], respectively, of the memory address 136. Moreover, the routing protocol 206 routes a first grouping of source bit positions and [1_{O}] (e.g., the bank 114 ID) of the offset identifier 132 to destination bit positions [7] and [8], respectively, of the memory address 136. In addition, the routing protocol 206 routes a next, successive grouping of source bit positions [2_{O}], [3_{O}], and [4_{O}] (e.g., the bank column ID) of the offset identifier 132 to destination bit positions [1], [2], and [3], respectively, of the memory address 136. Furthermore, the routing protocol 206 routes a next, successive grouping of source bit positions [5_{O}], [6_{O}], and [7_{O}] (e.g., the bank row ID) of the offset identifier 132 to destination bit positions [14], [15], and [16], respectively, of the memory address 136.

Once the routing protocol 206 is written to the machine status registers 202, the reconfigurable routing logic 140 reconfigures the barrel shifters 204 to implement the routing protocol 206 specified via the machine status registers 202. Barrel shifters 204, for instance, are digital circuits that are programmable to shift input data by a specified number of bits. In accordance with the described techniques, therefore, barrel shifter [0] shifts bit [0_{P}] of the PIM unit identifier 130 by a certain number of bits, barrel shifter [1] shifts bit [1_{P}] of the PIM unit identifier 130 by a certain number of bits, and so on. Further, barrel shifter [n] shifts bit [0_{O}] of the offset identifier 132 by a certain number of bits, barrel shifter [n+1] shifts bit [1_{O}] of the offset identifier 132 by a certain number of bits, and so on, e.g., n is the number of bits in the PIM unit identifier 130.

To reconfigure the barrel shifters 204, the reconfigurable routing logic 140 updates the number of bits by which the barrel shifters 204 are configured to shift respective input bits. By way of example, the reconfigurable routing logic 140 programs barrel shifter [0] to shift bit [0_{P}] of the PIM unit identifier 130 by four bits based on the value [4] in the machine status register 202a. Further, the reconfigurable routing logic 140 programs barrel shifter [1] to shift bit [1_{P}] of the PIM unit identifier 130 by four bits based on the value [5] in the machine status register 202a. The remaining barrel shifters 204 are similarly programmed to implement the routing protocol 206 specified by the machine status registers 202.

After the barrel shifters 204 have been reconfigured, the reconfigurable routing logic 140 generates a memory address 136 for the access request 126. To do so, the PIM unit identifier 130 and the offset identifier 132 are input to corresponding barrel shifters 204. Further, the barrel shifters 204 output the memory address 136 by shifting the source bits of the identifiers 130, 132 by the programmed amounts. In other words, the barrel shifters 204 generate the memory address 136 for the access request 126 based on the routing protocol 206 specified via the machine status registers 202. Once the memory address 136 is generated, the host processor 102 processes the access request 126 by accessing the requested element of the data structure 116 from the memory address 136.

In various implementations, the barrel shifters 204 perform respective shift operations in parallel, e.g., the barrel shifters 204 implement parallel shifting techniques. Notably, barrel shifters 204 capable of performing larger shift operations occupy a larger hardware footprint than barrel shifters 204 capable of performing smaller shift operations. In order to reduce hardware footprint in the system, the reconfigurable routing logic 140 imposes a maximum shift amount in various implementations, thereby enabling implementation of barrel shifters with smaller hardware footprints.

Although examples are depicted and described herein with reference to a particular number of machine status registers 202 corresponding to particular memory components, these examples are not to be construed as limiting. Indeed, the reconfigurable routing logic 140 includes any number of machine status registers 202, and the machine status registers 202 specify the routing protocol for different memory components, e.g., memory channels, memory ranks, PIM units, bank groups, banks, rows, columns, etc. Moreover, although the machine status registers 202 are depicted as including seven entries each, the machine status registers 202 include different numbers of entries in variations.

In at least one example, the machine status register 202e is removed, and the routing protocol 206 for the row identification bits are implicitly derived from the bit positions of the memory address 136 that are not specified by the other machine status registers 202a, 202b, 202c, 202d. Additionally or alternatively, one or more machine status registers 202 are assigned to specifying the routing protocol 206 for more than one memory component. By way of example, a single machine status register 202 is populatable to specify the routing protocol 206 for the bank identification bits of the offset identifier 132 and the column identification bits of the offset identifier 132.

FIG. 3 depicts a non-limiting example 300 of a layout of a matrix in memory for efficient execution of general matrix-vector multiplication operations using processing-in-memory. As shown, the example 300 includes the memory 110, and the memory 110 includes four PIM units 112a, 112b, 112c, 112d communicatively coupled to banks 114a, 114b, 114c, 114d, respectively. Although not depicted, the PIM units 112 are communicatively coupled to one or more other banks 114 of the memory 110, in various implementations. By way of example, each of the PIM units 112a, 112b, 112c, 112d operate on an odd bank and an even bank of the memory 110, and the depicted banks 114a, 114b, 114c, 114d are the odd banks to which the PIM units 112a, 112b, 112c, 112d are communicatively coupled.

In the example 300, the PIM units 112a, 112b, 112c, 112d are SIMD in-memory processors each having two lanes that are capable of performing a single operation on different data in parallel. Further, each lane of the PIM units 112a, 112b, 112c, 112d and each column of the banks 114a, 114b, 114c, 114d have a width corresponding to the width of a single data element. For computing systems operating in a thirty-two bit base type, for example, each data element is thirty-two bits wide, each lane is thirty-two bits wide, and each column 302a, 302b, 302c, 302d is thirty-two bits wide.

Thus, in the example in which each PIM unit 112a, 112b, 112c, 112d includes two lanes, the column 302a is mapped to a first lane of the PIM units 112a, 112b, 112c, 112d, the column 302b is mapped to a second lane of the PIM units 112a, 112b, 112c, 112d, the column 302c is mapped to the first lane of the PIM units 112a, 112b, 112c, 112d, and the column 302d is mapped to the second lane of the PIM units 112a, 112b, 112c, 112d. For instance, the data stored in column 302a of the bank 114a is operated on by loading the data directly into the first lane of the PIM unit 112a without first shifting the data within registers of the PIM unit 112a.

In addition, the example 300 includes a matrix 304 having four columns and sixteen rows (e.g., a four (x) by sixteen (y) matrix), and having data elements corresponding to each unique row and column combination. The matrix 304 includes entries denoted with positional notation [x, y] in which [x] indicates a column index of the entry and y indicates a row index of the matrix 304. General matrix-vector multiplication (GEMV) operations involve multiplying an input vector 306 and a matrix 304 to produce an output vector 308. To generate an element of the output vector 308, the data elements in a row of the matrix 304 are multiplied with corresponding data elements of the input vector 306, and the multiplication results are accumulated together.

To calculate element [0] of the output vector 308, for instance, element [A] of the input vector 306 is multiplied with element [0,0] of the matrix 304, element [B] of the input vector 306 is multiplied with element [1,0] of the matrix 304, element [C] of the input vector 306 is multiplied with element [2,0] of the matrix 304, and element [D] of the matrix is multiplied with element [3,0] of the matrix 304. Further, the results of the multiplication operations are accumulated together to produce element [0] of the output vector 308. This process of multiplying the corresponding elements of a matrix row and the input vector 306 together, and accumulating the results is referred to as a reduction computation. Further, the reduction computation is repeated for each row of the matrix 304 to produce the output vector 308.

Since the multiplication results of the elements in a matrix row are accumulated together in a reduction computation, the elements in a matrix row are interacting elements for GEMV operations. As previously noted, the layout instructions 118 cause the matrix 304 to be laid out in a manner that supports efficient execution of operations on the matrix 304 using the PIM units 112. As part of this, interacting elements of the matrix 304 are stored in bank(s) that are local to just one PIM unit 112, and at locations in the bank(s) that are mapped to respective lanes of the multiple PIM units 112. The example 300 depicts a layout 310 of the matrix 304 in the banks 114a, 114b, 114c, 114d that accords with these storage parameters, and supports efficient execution of GEMV operations on data elements in the matrix 304.

In general, the arrows included in the matrix 304 of the example 300 illustrate how the data elements of the matrix 304 are stored in the layout 310. More specifically, the matrix 304 includes unit matrices (illustrated with the thick borders in the matrix 304) that are each two rows by two columns in size, and the data elements of a respective unit matrix are stored in a respective row of one of the banks 114a, 114b, 114c, 114d. Further, when the depicted arrow pattern crosses a thick border in the matrix 304, the host processor transitions to storing the data elements of the matrix 304 in a different bank 114 communicatively coupled to a different PIM unit 112.

Starting with element [0,0] of the matrix 304, therefore, the host processor 102 stores elements [0,0], [0.1], [1,0], [1,1] in columns 302a, 302b, 302c, 302d, respectively, of the bank 114a (communicatively coupled to the PIM unit 112a), as shown. Further, the host processor 102 stores data elements [0,2], [0,3], [1,2], [1,3] in columns 302a, 302b, 302c, 302d, respectively, of the bank 114b (communicatively coupled to the PIM unit 112b), as shown. Additionally, the host processor 102 stores data elements [0,4], [0,5], [1,4], [1,5] in columns 302a, 302b, 302c, 302d, respectively, of the bank 114c (communicatively coupled to the PIM unit 112c), as shown. Moreover, the host processor 102 stores data elements [0,6], [0,7], [1,6], [1,7] in columns 302a, 302b, 302c, 302d, respectively, of the bank 114d (communicatively coupled to the PIM unit 112d), as shown. This process is repeated for the remaining elements of the matrix 304 in accordance with the depicted arrow pattern.

By laying out the matrix 304 in memory 110 in the described manner, the interacting elements of the matrix 304 (e.g., elements belonging to a same row of the matrix 304) are local to respective PIM units 112a, 112b, 112c, 112d, and are stored at locations that map to respective lanes of the respective PIM units 112a, 112b, 112c, 112d. Consider, for example, the first matrix row including elements [0,0], [1,0], [2,0], and [3,0]. Here, element [0,0] and element [2,0] are stored in column 302a of bank 114a, while element [1,0] and element [3,0] are stored in column 302c of bank 114a. As previously mentioned, column 302a and column 302c map to a first lane of the PIM unit 112b. Given this, the interacting elements of the first matrix row are local to the PIM unit 112a, and are mapped to a first lane of the PIM unit 112a.

Similarly, consider the second matrix row including elements [0,1], [1,1], [2,1], and [3,1] as an example. Here, element [0,1] and [2,1] are stored in column 302b of the first bank 114a, while element [1,1] and element [3,1] are stored in column 302d of the first bank 114a. As previously mentioned, column 302b and column 302d map to a second lane of the PIM unit 112a. Given this, the interacting elements of the second matrix row are local to the PIM unit 112a, and are mapped to a second lane of the PIM unit 112a. Given this, the PIM unit 112a is able to perform a reduction computation of a GEMV operation on the first matrix row and the second matrix row in parallel. As shown, the remaining matrix rows are similarly laid out in the memory 110 across the banks 114a, 114b, 114c, 114d. Therefore, the reduction computation is performed on the first eight memory rows in parallel across the lanes of the PIM units 112a, 112b, 112c, 112d. Then, the reduction computation is performed on the next eight memory rows in parallel across the lanes of the PIM units 112a, 112b, 112c, 112d.

The layout 310 differs from conventional row-major or column-major layouts. These conventional layouts often lead to interacting elements of a matrix row being stored at banks communicatively coupled to different PIM units 112 and/or interacting elements of a matrix row being mapped to different lanes of a same PIM unit 112. Conventional techniques, therefore, utilize the host processor 102 to facilitate accesses to non-local banks of the PIM units 112 and/or rely on the host processor 102 for performing at least some of the reduction computations of a GEMV operation. Additionally or alternatively, conventional techniques utilize shift operations within registers of the PIM units 112 to align the interacting elements of a matrix row within lanes of a respective PIM unit 112.

In contrast, the described layout 310 enables parallel reduction computations of a GEMV operation to be performed across multiple lanes of multiple PIM units 112 entirely within the multiple PIM units 112, e.g., without relying on the host processor 102 to perform reduction computations. Further, the parallel reduction computations are performable without first shifting data within the registers of the PIM units 112, and without relying on the host processor 102 to obtain data from non-local banks of the PIM units 112. Accordingly, the described layout 310 enables increased computational speed in executing GEMV operations on matrices, as compared to conventional techniques.

Although the layout 310 of the example is described in the context of four PIM units 112 each having two SIMD lanes, it is to be appreciated that the described layout techniques are extendable to different numbers of PIM units 112 having different numbers of SIMD lanes, in variations. By way of example, the number of rows in a unit matrix corresponds to the number of SIMD lanes in each PIM unit 112. Thus, in an example in which each PIM unit 112 includes four SIMD lanes, the unit matrices are of size two columns by four rows.

FIG. 4a depicts a non-limiting example 400 of generating a memory address for an access request to access an element of a matrix having the layout of FIG. 3. The example 400 includes the routing logic 134 having the hardwired routing logic 138 and the reconfigurable routing logic 140. The routing logic 134 receives the access request 126 to access an element of the matrix 304 laid out in the manner described above with reference to FIG. 3, e.g., stored in the layout 310. Here, the routing logic 134 includes PIM unit/offset computation logic 402, and the PIM unit/offset computation logic 402 is leveraged to compute the PIM unit identifier 130 and the offset identifier 132 based on the input parameters 128 of the access request, e.g., rather than the PIM unit identifier 130 and the offset identifier 132 being provided directly via the input parameters 128.

To facilitate computation of the PIM unit identifier 130 and the offset identifier 132, the input parameters 128 include element parameters 404 indicating the element of the matrix 304 that is requested to be accessed. In particular, the element parameters 404 include a row index 406 indicating a particular matrix row associated with the requested element, and a column index 408 indicating a particular matrix column associated with the requested element.

As shown, the input parameters 128 further include layout parameters 410 indicating the layout 310. In particular, the layout parameters 410 include an indication of a number of bank column bits 412 allocated to the matrix 304 in each of the banks 114. Notably, the number of bank column bits 412 is equal to the number of columns allocated to the matrix 304 in each of the banks 114 (e.g., four columns 302a, 302b, 302c, 302d in the example 300) multiplied by the size of the data elements in the columns. The layout parameters 410 further include a number of lanes 414 included in each PIM unit 112, a number of PIM units 416 in the memory 110, a number of matrix columns 418 in the matrix 304, and a base type size 420 indicating a size of the data elements in the matrix 304. For instance, the base type size 420 is thirty-two bits (e.g., four bytes) for computing systems operating in a thirty-two bit base, or sixty-four bits (e.g., eight bytes) for computing systems operating in a sixty-four bit base.

In one or more examples, the input parameters 128 (e.g., the element parameters 404 and the layout parameters 410) are dedicated bits of the access request 126. For instance, the row index 406, the column index 408, the number of bank column bits 412, the number of lanes 414, the number of PIM units 416, the number of matrix columns 418, and the base type size 420 each correspond to a dedicated range of bit positions in the access request 126.

As shown, the input parameters 128 including the element parameters 404 and the layout parameters 410 are provided, as input, to the PIM unit/offset computation logic 402. Broadly, the PIM unit/offset computation logic 402 is configured to compute the PIM unit identifier 130 and the offset identifier 132 based on the input parameters 128. To do so, the following pseudocode is implemented by the PIM unit/offset computation logic 402:

$$elementsPerRow = Bank Column Bits \div Base Type Size \qquad ( 1 )$$

$$RowsPerSet = Lanes \times PIM Units \qquad ( 2 )$$

$$yPerUnit = Lanes \qquad ( 3 )$$

$$xPerUnit = elementsPerRow \div Lanes \qquad ( 4 )$$

$$UnitsPerSetPerPIM = Matrix Columns \div ( elementsPerRow \div Lanes ) \qquad ( 5 )$$

$$SetSize = UnitsPerSetPerPIM \times elementsPerRow \times PIM Units \qquad ( 6 )$$

$$SetOffset = ( Row Index \div RowsPerSet ) \times SetSize \qquad ( 7 )$$

$$BatchOffset = ( ColumnIndex \div xPerUnit ) \times elementsPerRow \times PIM Units \qquad ( 8 )$$

$$BlockNumber = Column Index \% xPerUnit \qquad ( 9 )$$

$$BlockOffset = Row Index \% Lanes \qquad ( 10 )$$

$$PIM Unit I D = ( Row Index \div yPerUnit ) \% PIM Units \qquad ( 11 )$$

$$Location = SetOffset + ( PIM Unit I D \times elementsPerRow ) + BatchOffset + ( BlockNumber \times Lanes ) + blockOffset \qquad ( 12 )$$

$$Extended Location = Location \times Base Type Size \qquad ( 13 )$$

$$Column Address = Extended Location \& ( Bank Column Bits - 1 ) \qquad ( 14 )$$

$$Row Address = Extended Location \div ( Bank Columns Bits \times PIM Units ) \qquad ( 15 )$$

$$Local Offset = ( Row Address \times Bank Column Bits ) + Column Address \qquad ( 16 )$$

In the following discussion, an example is discussed in which element [2, 11] is accessed from the layout 310 of the matrix 304 in the memory 110 using the pseudocode above. Here, the row index 406 is eleven and the column index 408 is two, and the base type size 420 is thirty-two bits. Given this, the number of bank column bits 412 is equal to 128 bits, e.g., four columns 302a, 302b, 302c, 302d allocated to the matrix 304 in each of the banks 114a, 114b, 114c, 114d multiplied by thirty-two bits per data element. Furthermore, the number of lanes 414 is equal to two, the number of PIM units 416 is equal to four, and the number of matrix columns 418 is equal to four.

FIG. 4b depicts non-limiting examples 422, 424, 426, 428 of different partitionable portions of the matrix of FIG. 3. Indeed, for purposes of the discussion, the matrix 304 is conceptualizable as partitioned into blocks, unit matrices, batch matrices, and set matrices. For instance, a block is a portion of a unit matrix that fits within a single lane of an in-memory SIMD processor, and is illustrated with the thick borders in example 422. As shown, a block is one column by two rows, e.g., a first block includes elements [0,0] and [0,1], a second block includes elements [1,0] and [1,1], a third block includes elements [0,2] and [0,3], and so on. As previously discussed, a unit matrix is a portion of the matrix 304 that is mapped to a respective row of a respective bank 114, and is illustrated by the thick borders in example 424. As illustrated, a unit matrix is two columns by two rows in the matrix 304, and each unit matrix includes two blocks.

Furthermore, a batch matrix is a portion of the matrix 304 that is mapped to a respective row across each of the PIM units 112 in the system, and is illustrated by the thick borders in example 426. In the present example, a batch matrix is two columns by eight rows and includes four unit matrices. Following the depicted arrow pattern in the matrix 304, for instance, a first batch matrix 430a includes elements [0,0] through [1,7], a second batch matrix 430b includes elements [2,0] through [3,7], a third batch matrix 430c includes elements [0,8] through [1,15], and a fourth batch matrix 430d includes elements [2,8] through [3,15]. Finally, a set matrix is a portion of the matrix 304 that is processable in parallel by the PIM units 112 in the system, and is illustrated by the thick borders in example 428. In the present example, a set matrix is four columns by eight rows. For instance, a first set matrix 432a includes the first batch matrix 430a and the second batch matrix 430b, while a second set matrix 432b includes the third batch matrix 430c and the fourth batch matrix 430d.

It should be noted that various components of the memory (e.g., the PIM units 112, the lanes of the PIM units 112, the banks 114, the rows and the columns of the banks 114) and various components of the matrix 304 (e.g., set matrices, batch matrices within a set matrix, blocks within a unit matrix) in the following discussion are associated with numerical identifiers, in which component sets are numbered starting with a numerical identifier of zero. For instance, PIM unit 112a (e.g., a first PIM unit 112 in the system) is associated with a numerical ID of zero, PIM unit 112b (e.g., a second PIM unit 112 in the system) is associated with a PIM unit identifier of one, and so on.

Returning now to FIG. 4a and the pseudocode above, elementsPerRow in line (1) of the pseudocode is the number of elements in the matrix 304 stored in respective rows of the banks 114, which is four in the present example. Further, RowsPerSet in line (2) of the pseudocode is the number of matrix rows that are processable in parallel by the PIM units 112 in the system, which is eight in the present example. Moreover, yPerUnit in line (3) of the pseudocode is the number of matrix rows in each unit matrix, as determined by the number of lanes in each PIM unit 112, which is two in the present example. Furthermore, xPerUnit in line (4) of the pseudocode is the number of columns in each unit matrix, which is also two in the present example.

Continuing with the example, UnitsPerSetPerPIM in line (5) of the pseudocode is the number of unit matrices in a set matrix to be processed by one PIM unit 112. In the present example, for instance, the first PIM unit 112a is configured to process two unit matrices in the first set matrix 432a-a first unit matrix including elements [0,0], [0,1], [1,0], and [1,1], and a second unit matrix including elements [2,0], [2,1], [3,0], and [3,1], e.g., the UnitsPerSetPerPIM is two in the present example. Further, SetSize in line (6) of the pseudocode is the number of elements in a set matrix, which is thirty-two in the present example.

Moreover, SetOffset in line (7) of the pseudocode is the offset of the requested element (e.g., relative to element [0,0] and following the depicted arrow pattern) in the matrix 304 that identifies the first element of the set matrix (e.g., the set base) to which the requested element belongs. Notably, the result of a division operation in the pseudocode above is a whole number, and not a fraction or a decimal. As such, the Row Index, eleven, divided by the RowsPerSet, eight, in line (7) of the pseudocode is equal to one in the present example. Given the above, the SetOffset of each element in the first set matrix 432a is zero, while the SetOffset of each element in the second set matrix 432b is thirty-two. Since element [2, 11] is in the second set matrix, the SetOffset value in the present example is thirty-two elements.

Furthermore, BatchOffset in line (8) of the pseudocode is the offset of the requested element in the matrix 304 relative to the set base, such that the BatchOffset identifies the first element of the batch matrix (e.g., the batch base) to which the requested element belongs. Notably, the BatchOffset of each element in the batch matrix 430c (e.g., the first batch matrix of the second set matrix 432b) is zero, while the SetOffset of each element in the batch matrix 430d (e.g., the second batch matrix of the second set matrix 432b) is sixteen. Since the element [2, 11] belongs to the batch matrix 430d in the second set matrix 432b, the BatchOff set value in the present example is sixteen elements.

The BlockNumber in line (9) of the pseudocode identifies the particular block within the unit matrix to which the requested element belongs. Notably, the [%] operator is a modulo operator, in which a % b returns a remainder of the division operation a÷b. Here, element [2, 11] belongs to a first block (e.g., having a numerical identifier of zero) of the unit matrix including elements [2, 10], [2, 11], [3,10], and [3,11]. Accordingly, the BlockNumber in the present example is zero. The BlockOffset of line (10) in the pseudocode identifies the lane of the PIM unit 112 to which the requested element is mapped. For example, element [2, 11] is mapped to a second lane (e.g., having a numerical identifier of one) of the PIM unit 112b, and as such, the BlockOffset in the present example is one.

Furthermore, the PIM Unit ID in line (11) of the pseudocode refers to the PIM unit 112 to which the requested element is mapped, i.e., the PIM Unit ID is the PIM unit identifier 130. Here, the element [2,11] is mapped to the second PIM unit 112b of the system (e.g., having a numerical identifier of one), and as such, the PIM Unit ID in the present example is one. Moreover, Location in line (12) of the pseudocode refers to the offset of the element relative to element [0, 0] of the matrix 304 and following the depicted arrow pattern. For example, the Location value for element [0,0] is zero elements, the Location value for element [0,1] is one element, the Location value for element [1,0] is two elements, the Location value for element [1,1] is three elements, the Location value for element [0,2] is four elements, and so on. Given this, the Location value for element [2,11] is fifty-three elements in the present example. The Extended Location value in line (13) is the offset of the element in number of bits, rather than number of elements, relative to element [0,0] of the matrix 304. Thus, the Extended Location for element [2,11] is 1,696 bits in the present example.

The Column Address of line (14) in the pseudocode identifies the starting column bit for the requested element in the bank 114 where the requested element is stored. Since each element is thirty-two bits and the element [2,11] is stored in the second column of the bank 114b, the starting column bit (e.g., the Column Address) for the element [2,11] is thirty-two. The Row Address of line (15) in the pseudocode identifies the row of the bank 114 where the requested element is stored. In the present example, the element [2,11] is stored in the fourth row (e.g., having a numerical identifier of three) of the bank 114b, and as such, the Row Address for element [2,11] is three.

Finally, the Local Offset is the offset of the requested element in the bank 114b where the element is stored given the column address and the row address, i.e., Local Offset is the offset identifier 132. Since element [2, 11] is the second element in the fourth row of the bank 114b, the offset of the element [2, 11] in the bank 114b is thirteen elements or 416 bits. Therefore, the Local Offset value in the present example is 416 bits. Although represented in number of bits in this example, it is to be appreciated that the pseudocode is carried out to represent the Local Offset value in number of bytes and/or number of elements in variations.

Although the elements of the matrix 304 are mapped to just one bank 114 in the present example, it is to be appreciated that the PIM units 112 are communicatively coupled to more than one bank in variations. In accordance with these implementations, the Local Offset value (e.g., the offset identifier 132) implicitly includes an identifier of the particular bank 114 of the multiple banks 114 operated on by the PIM unit 112, e.g., identified by the PIM Unit ID of line (11) of the pseudocode. For example, the Local Offset value is relative to a bank base, and the bank base identifies a starting point of the first element of the first bank 114 of multiple banks 114 operated on by the PIM unit 112. Given this, the Local Offset value implicitly determines which bank 114 (of the multiple banks operated on by the PIM unit 112) stores the requested element, e.g., a sufficiently large Local Off set value places the requested element in a second bank of the PIM unit 112 rather than a first bank of the PIM unit 112.

It should be noted that many of the input parameters 128 are powers of two regardless of the size of the matrix 304, namely the bank column bits 412, the number of lanes 414, the number of PIM units 416, and the base type size 420. Further, division and multiplication operations on binary values that are powers of two are logically shift operations, while modulo operations on binary values that are powers of two are logically AND [&] operations. Given the above, multiplication/division operations and/or modulo operations that operate on values that are powers of two in the pseudocode above are shift operations and/or AND [&] operations, respectively. In order to facilitate these operations (e.g., AND [&] operations and shift operations), the matrix 304 is padded with a layer of zero values in one or more implementations. Notably, AND [&] operations and shift operations are processable with increased computational efficiency than modulo operations and multiplication/division operations.

Once computed, the PIM unit identifier 130 (e.g., the PIM Unit ID of line (11) of the pseudocode) and the offset identifier 132 (e.g., the Local Offset of line (16) of the pseudocode) are provided as input to either the hardwired routing logic 138 or the reconfigurable routing logic 140, as shown. Further, the routing logic 134 leverages the hardwired routing logic 138 or the reconfigurable routing logic 140 to generate a memory address 136 for the access request 126 in accordance with the described techniques.

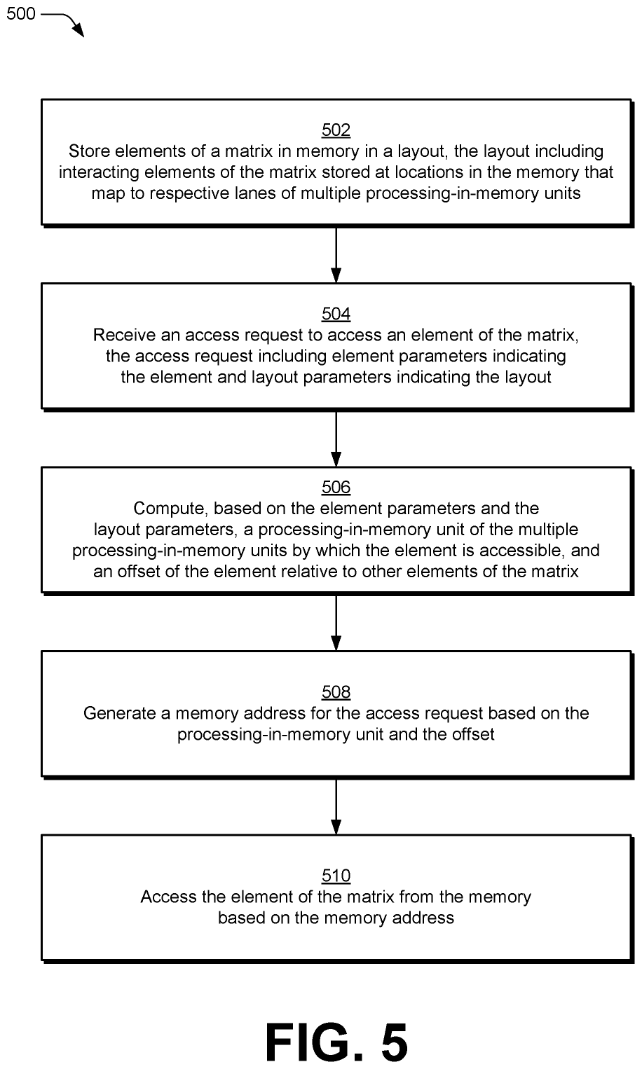

FIG. 5 depicts a procedure 500 in an example implementation of host accesses to processing-in-memory oriented data structures. In the procedure 500, elements of a matrix are stored in memory in a layout, and the layout includes interacting elements of the matrix stored at locations in the memory that map to respective lanes of multiple processing-in-memory units (block 502). By way of example, the host processor 102 issues layout instructions 118 for storing a matrix 304 in memory 110. The layout instructions 118 cause interacting elements of the matrix 304 to be stored in one or more banks 114 that are local to a respective PIM unit 112. In addition, the layout instructions 118 cause interacting elements of the matrix 304 to be stored at locations in the memory 110 that map to respective lanes of the multiple PIM units 112. In one or more implementations, a respective set of interacting elements of the matrix 304 include the elements belonging to a respective row of the matrix 304, and the elements are “interacting” in the sense that the elements are combinable as part of a reduction computation of a GEMV operation. The layout 310 of FIG. 3 is an example of how the layout instructions 118 store the interacting elements of the matrix 304 for GEMV operations.

An access request is received to access an element of the matrix, and the access request includes element parameters indicating the element and layout parameters indicating the layout (block 504). By way of example, the routing logic 134 of the host processor 102 receives an access request 126 to access an element of the matrix 304 laid out in memory 110 in accordance with the layout 310. Here, the input parameters 128 include element parameters 404 indicating the particular element of the matrix 304 that is requested, and layout parameters 410 indicating the layout 310.

In particular, the element parameters 404 include a row index 406 indicating a row of the matrix 304 associated with the requested data element and a column index 408 indicating a column of the matrix 304 associated with the requested data element. Further, the layout parameters 410 include a number of bank column bits 412 allocated to the matrix 304 in the one or more banks 114 of the multiple PIM units 112, a number of lanes 414 in each PIM unit 112, a number of PIM units 416 in the system, a number of matrix columns 418 in the matrix 304, and a base type size 420 for elements in the matrix 304.

A processing-in-memory unit of the multiple processing-in-memory units by which the element is accessible, and an offset of the element relative to other elements of the matrix are computed based on the element parameters and the layout parameters (block 506). By way of example, the PIM unit/offset computation logic 402 receives the input parameters 128, and computes a PIM unit identifier 130 and an offset identifier 132 based on the input parameters 128. To do so, the PIM unit/offset computation logic 402 utilizes the pseudocode discussed above with reference to FIGS. 4a and 4b. Notably, the PIM unit identifier 130 includes a set of bits that are a binary identifier of a PIM unit 112 that operates on the one or more banks 114 where the requested element is stored, and a set of bits that are a binary identifier of a memory channel to which the bank 114 belongs. Further, the offset identifier 132 includes a set of bits that are a binary identifier of the particular bank 114 in which the element is stored (e.g., of the one or more banks operated on by the PIM unit 112), a set of bits that are a binary identifier of a row of the particular bank 114 where the element is stored, and a set of bits that are a binary identifier of a column of the particular bank 114 where the element is stored.

A memory address is generated for the access request based on the processing-in-memory unit and the offset (block 508). For example, the routing logic 134 of the host processor 102 receives an indication of a mapping 122 of the physical address map 124 for the workload 120 that includes the access request 126. Notably, the mapping 122 defines bit positions of a memory address 136 as assigned to different components of the memory 110. For example, the mapping 122 defines memory channel bits that are populatable to specify a particular memory channel for a memory address 136, PIM unit bits that are populatable to specify a particular PIM unit 112 that is configured for accessing the memory address 136, bank bits that are populatable to specify a particular bank 114 operated on by the particular PIM unit 112 where the memory address 136 is located, and row bits and column bits that are populatable to specify a particular row and column pair where the memory address 136 is located.

In addition, the routing logic 134 receives the PIM unit identifier 130 and the offset identifier 132, e.g., as computed by the PIM unit/offset computation logic 402. In accordance with the described techniques, the routing logic 134 implements a routing protocol corresponding to the mapping 122 specified for the workload 120. For instance, the routing protocol specifies how source bit positions of the PIM unit identifier 130 and the offset identifier 132 are to be routed to destination bit positions of the memory address 136 that are assigned (based on the mapping 122) to respective components of the memory 110.

The element of the matrix is accessed from the memory based on the memory address (block 510). For example, the host processor 102 accesses the data element requested by the access request 126 from the location in memory 110 indicated by the memory address 136.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host processor 102, the memory module 104, the core 106, the memory controller 108, the memory 110, the PIM units 112, the routing logic 134, the hardwired routing logic 138, the reconfigurable routing logic 140, the machine status registers 202, the barrel shifters 204, and the PIM unit/offset computation logic 402) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A computing device, comprising:
a memory;
multiple processing-in-memory units, each processing-in-memory unit configured to access one or more banks of the memory; and
a host processor configured to:
receive an access request to access an element of a data structure stored in the memory, the access request including input parameters indicating a processing-in-memory unit of the multiple processing-in-memory units by which the element is accessible, and an offset of the element relative to other elements of the data structure; and
generate a memory address for the access request based on the processing-in-memory unit and the offset, the element of the data structure being accessed based on the memory address.

2. The computing device of claim 1, wherein the processing-in-memory unit and the offset are specified directly via the input parameters.

3. The computing device of claim 1, wherein the offset further indicates a particular bank of the one or more banks that the processing-in-memory unit is configured to access.

4. The computing device of claim 1, wherein the host processor is configured to generate the memory address using a physical address map, the physical address map including one or more mappings that assign bit positions of the memory address to corresponding components of the memory.

5. The computing device of claim 4, wherein the corresponding components of the memory include memory channels, the multiple processing-in-memory units, banks of the memory, rows of the banks, and columns of the banks.

6. The computing device of claim 4, wherein the processing-in-memory unit and the offset are indicated by one or more numerical identifiers, and to generate the memory address, the host processor is configured to route source bits of the one or more numerical identifiers to the bit positions of the memory address in accordance with a routing protocol corresponding to a mapping of the physical address map.

7. The computing device of claim 6, wherein the routing protocol is hardwired into the host processor.

8. The computing device of claim 6, wherein the routing protocol is implemented by barrel shifters of the host processor that are reconfigurable to account for different mappings of the physical address map.

9. The computing device of claim 8, wherein the access request is received as part of a workload, and to generate the memory address, the host processor is configured to:
receive an indication of the mapping of the physical address map associated with the workload;
update machine status registers of the host processor to specify the routing protocol corresponding to the mapping; and
reconfigure the barrel shifters to implement the routing protocol as specified by the machine status registers.

10. The computing device of claim 1, wherein the host processor is configured to store elements of the data structure in the memory in a layout, the layout including interacting elements of the data structure stored at locations in the memory that are local to respective processing-in-memory units of the multiple processing-in-memory units.

11. The computing device of claim 10, wherein the multiple processing-in-memory units correspond to single instruction, multiple data processing-in-memory units each having multiple lanes, the layout further including the interacting elements of the data structure stored at the locations in the memory that map to respective lanes of the multiple processing-in-memory units.

12. The computing device of claim 11, wherein the input parameters include element parameters indicating the element of the data structure and layout parameters indicating the layout, and the host processor is further configured to compute the processing-in-memory unit and the offset based on the element parameters and the layout parameters.

13. A system, comprising:
a memory module including a memory and multiple processing-in-memory units each configured to access one or more banks of the memory; and
a host processor communicatively coupled to the memory module, the host processor configured to:
store elements of a matrix in the memory in a layout, the layout including interacting elements of the matrix stored at locations in the memory that map to respective lanes of the multiple processing-in-memory units;
receive an access request to access an element of the matrix, the access request including element parameters indicating the element, and layout parameters indicating the layout; and
compute, based on the element parameters and the layout parameters, a processing-in-memory unit of the multiple processing-in-memory units by which the element is accessible and an offset of the element relative to other elements of the matrix, the element of the matrix being accessed based on the processing-in-memory unit and the offset.

14. The system of claim 13, wherein the interacting elements include the elements of the matrix that are combinable as part of a reduction computation of a general matrix-vector multiplication operation.

15. The system of claim 13, wherein the element parameters include a row of the matrix and a column of the matrix associated with the element.

16. The system of claim 13, wherein the layout parameters include:
a first number of bank columns allocated to the matrix in the one or more banks of the multiple processing-in-memory units;
a second number of lanes included in each of the multiple processing-in-memory units;
a third number of the multiple processing-in-memory units;
a fourth number of matrix columns in the matrix; and
a base type size of the elements in the matrix.

17. The system of claim 13, wherein the host processor is further configured to generate a memory address for the access request based on the processing-in-memory unit and the offset, the memory address generated using a physical address map that includes one or more mappings that assign bit positions of the memory address to different components of the memory, the element of the matrix being accessed based on the memory address.

18. The system of claim 17, wherein the processing-in-memory unit and the offset are indicated by one or more numerical identifiers, and to generate the memory address, the host processor is configured to route source bits of the one or more numerical identifiers to the bit positions of the memory address in accordance with a routing protocol corresponding to a mapping of the physical address map specified for a workload that includes the access request.

19. A method, comprising:
receiving, by a host processor, an access request of a workload to access an element of a data structure stored in memory, the access request including numerical identifiers of a processing-in-memory unit that is configured to access a bank where the element is stored and an offset of the element relative to other elements of the data structure;
generating, by the host processor, a memory address for the access request using a routing protocol indicating how source bits of the numerical identifiers are routed to bit positions of the memory address assigned to respective components of the memory; and
accessing, by the host processor, the element of the data structure based on the memory address.

20. The method of claim 19, wherein the routing protocol is implemented in hardware of the host processor that is reconfigurable to account for different mappings of bit positions of the memory address to corresponding components of the memory, and generating the memory address includes:
receiving a mapping associated with the workload;
updating machine status registers of the host processor to specify the routing protocol corresponding to the mapping; and
reconfiguring the hardware to implement the routing protocol as specified by the machine status registers.
